(19) United States
(12) Patent Application Publication
(10) Pub. No.: US 2026/0092190 A1
(43) Pub. Date: Apr. 2, 2026

(54) Radiation Curable Ink Composition For Ink Jet And Recording Apparatus

(71) Applicant: SEIKO EPSON CORPORATION, Tokyo (JP)

(72) Inventors: Chigusa SATO, Matsumoto (JP); Yoshinobu YOSHIDA, Shiojiri (JP); Emi TAKEUCHI, Shiojiri (JP)

(21) Appl. No.: 19/341,111

(22) Filed: Sep. 26, 2025

(30) Foreign Application Priority Data
Sep. 27, 2024 (JP) 2024-168797

(51) Int. Cl. C09D 11/38; C08K 5/5313; C08K 5/5397; C09D 11/326

(52) U.S. Cl. CPC C09D 11/38; C08K 5/5313; C08K 5/5397; C09D 11/326

(57) ABSTRACT

There is provided a radiation curable ink composition for ink jet, which contains a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C).

The present application is based on, and claims priority from JP Application Serial Number 2024-168797, filed Sep. 27, 2024, the disclosure of which is hereby incorporated by reference herein in its entirety.

### BACKGROUND

### 1. Technical Field

The present disclosure relates to a radiation curable ink composition for ink jet and a recording apparatus.

### 2. Related Art

An ink jet recording method enables high resolution recording with a relatively small apparatus, and a lot of related techniques are being developed. For example, a radiation curable ink for use application to packaging is being developed, and JP-A-2024-33318 discloses a photocurable ink composition for ink jet, which contains a thioxanthone polymerization initiator and an amine-modified oligomer, where the photocurable ink composition for ink jet reduces migration and can also be used for use application to food packaging.

However, the radiation curable ink for ink jet has a specific odor. Therefore, in order to further expand the use application, it is required to reduce the odor of the ink. In addition, the ink for ink jet is required to have good curability and anti-blocking properties.

### SUMMARY

According to an aspect of a radiation curable ink composition for ink jet according to the present disclosure, the radiation curable ink composition for ink jet contains a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C).

According to an aspect of a recording apparatus according to the present disclosure, the above-described radiation curable ink composition for ink jet, and a head that ejects the radiation curable ink composition for ink jet are provided.

### BRIEF DESCRIPTION OF THE DRAWINGS

FIG. 1 is a perspective view of an example of a recording apparatus.

FIG. 2 is a front view of an ultraviolet irradiation apparatus illustrated in FIG. 1.

FIG. 3 is a view taken in an arrow direction along a line III-III in FIG. 2.

FIG. 4 is a schematic view of an example of a recording apparatus.

FIG. 5 is Table 1 showing the compositions and the like of examples.

FIG. 6 is Table 2 showing the compositions and the like of examples.

FIG. 7 is Table 3 showing the compositions and the like of examples.

FIG. 8 is Table 4 showing the compositions and the like of examples and comparative examples.

FIG. 9 is Table 5 showing the evaluation results of examples and comparative examples.

### DESCRIPTION OF EMBODIMENTS

Hereinafter, embodiments of the present disclosure will be described. The embodiments described below describe examples of the present disclosure. The present disclosure is not limited to the following embodiments and includes various modification forms implemented in a range that does not change the gist of the present disclosure. It is noted that not all of the configurations described below are essential configurations of the present disclosure.

### 1. Radiation Curable Ink Composition for Ink Jet

A radiation curable ink composition for ink jet according to the present embodiment contains a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C).

### 1.1. Hydroxyl Group-Containing Polymerizable Compound (A)

The radiation curable ink composition for ink jet according to the present embodiment contains a hydroxyl group-containing polymerizable compound (A). Examples of the hydroxyl group-containing polymerizable compound (A) include a monofunctional polymerizable compound and a polyfunctional polymerizable compound containing a hydroxyl group among polymerizable compounds. More specifically, the hydroxyl group-containing polymerizable compound (A) is preferably hydroxyalkyl (meth)acrylate, hydroxy (meth)acrylate having an alicyclic structure, a hydroxyl group-containing epoxy (meth)acrylate, or the like among the polymerizable compounds having a hydroxyl group in the molecule.

It is noted that, in the present specification, in a case where “(meth)acrylate” is described, it means acrylate or methacrylate, and in a case where “(meth)acrylic” is described, it means acrylic or methacrylic. It is noted that a value obtained by measurement using a mass analysis method is employed as the weight average molecular weight in the present specification.

Examples of the hydroxy (meth)acrylate include 2-hydroxyethyl acrylate (HEA), 2-hydroxyethyl methacrylate, 2-hydroxypropyl acrylate (HPA), 2-hydroxypropyl methacrylate, acrylic acid 2-hydroxy-3-phenoxypropyl ester (HPPA), methacrylic acid 2-hydroxy-3-phenoxypropyl ester, 4-hydroxybutyl acrylate (4HBA), and 4-hydroxybutyl methacrylate.

Examples of the hydroxy (meth)acrylate having an alicyclic structure include 1,4-cyclohexanedimethanol monoacrylate (CHDMMA) and 1,4-cyclohexanedimethanol monomethacrylate.

Examples of the hydroxyl group-containing epoxy (meth)acrylate include an epoxy acrylate obtained by adding (meth)acrylic acid to a diepoxy or polyepoxy compound. Such an epoxy (meth)acrylate can be available as a commercially available product, and examples thereof include DA-111, DA-141, DA-212, DA-250, DA-314, DA-721, DA-722, DA-911M, DA-920, DA-931, DM-201, DM-811, DM-832, and DM-851 (all of which are manufactured by Nagase ChemteX Corporation).

Among the above-described compounds, the hydroxyl group-containing polymerizable compound (A) contained in the radiation curable ink composition for ink jet is preferably a monofunctional polymerizable compound containing a hydroxyl group, and it is more preferable to select one or more compounds selected from 2-hydroxyethyl acrylate (HEA), 2-hydroxypropyl acrylate (HPA), 2-hydroxypropyl methacrylate (HPMA), acrylic acid 2-hydroxy-3-phenoxypropyl ester (HPPA), and 4-hydroxybutyl acrylate (4HBA).

In a case where the hydroxyl group-containing polymerizable compound (A) is selected as described above, the radiation curable ink composition for ink jet is likely to be adjusted to have a viscosity, thereby being more suitable as a composition for ink jet, and the adhesiveness of a cured product of a coating film of the composition to the recording medium can be further improved. The reason why the adhesiveness can be improved is considered to be that the bulkiness of the molecule is increased by containing a hydroxyl group, and the shrinkage during polymerization is reduced as compared with a polymerizable compound having no hydroxyl group, and the residual stress of the ink coating film is reduced. In addition, in a case where the monofunctional polymerizable compound is used, the above effect is more likely to be obtained because the monofunctional polymerizable compound contains a large number of hydroxyl groups per polymerizable functional group.

It is noted that one kind of the hydroxyl group-containing polymerizable compound (A) may be used alone, or two or more kinds thereof may be used in combination.

The content of the hydroxyl group-containing polymerizable compound (A) is preferably 5% by mass or more, more preferably 7% by mass or more, and still more preferably 10% by mass or more with respect to the total amount of the radiation curable ink composition for ink jet. In a case where the content of the hydroxyl group-containing polymerizable compound (A) is within the above-described range, the flexibility of the cured product of the ink composition is further improved, which makes it possible to further improve the adhesiveness of the ink composition to the recording medium and makes it possible to further improve the anti-blocking properties of the coating film. In addition, the above-described content is preferably 40% by mass or less, more preferably 35% by mass or less, and still more preferably 30% by mass or less.

### 1.2. Monofunctional Polymerizable Compound (B)

The radiation curable ink composition for ink jet according to the present embodiment contains a monofunctional polymerizable compound other than the above-described hydroxyl group-containing polymerizable compound (A), where the monofunctional polymerizable compound is a monofunctional polymerizable compound (B) having a glass transition temperature of 10° C. or higher and 90° C. or lower.

In the present specification, the glass transition temperature (Tg) of the polymerizable compound is defined as a glass transition temperature (Tg) of a polymer in a case where the polymerizable compound forms a homopolymer. The glass transition temperature can be determined, for example, by differential scanning calorimetry (DSC) or viscoelasticity measurement, and it is more preferably determined by differential scanning calorimetry (DSC).

The monofunctional polymerizable compound (B) other than the hydroxyl group-containing polymerizable compound (A) having a glass transition temperature of 10° C. or higher and 90° C. or lower (hereinafter, may be simply referred to as a “monofunctional polymerizable compound (B)”) is not particularly limited; however, a monofunctional polymerizable compound (B) having a cyclic skeleton is preferable. Examples of the monofunctional polymerizable compound having a cyclic skeleton include a nitrogen-containing heterocyclic ring-containing polymerizable compound, a hydrocarbon ring-containing polymerizable compound, and a cyclic ether-containing polymerizable compound. In the present specification, the nitrogen-containing heterocyclic ring-containing polymerizable compound, the hydrocarbon ring-containing polymerizable compound, and the cyclic ether-containing polymerizable compound may be referred to as a nitrogen-containing heterocyclic polymerizable compound, a hydrocarbon ring polymerizable compound, and a cyclic ether polymerizable compound, respectively.

By using a monofunctional polymerizable compound having a cyclic skeleton, the curability and the abrasion resistance of the cured product of the ink composition can be improved.

Examples of the nitrogen-containing heterocyclic polymerizable compound include N,N-diethyl acrylamide (DEAA).

Examples of the hydrocarbon ring polymerizable compound include 4-tert-butylcyclohexyl acrylate (TBCHA), 3,3,5-trimethylcyclohexyl acrylate (TMCHA), isobornyl (meth)acrylate, and dicyclopentenyl (meth)acrylate.

Examples of the cyclic ether polymerizable compound include a cyclic trimethylolpropane formal acrylate (CTFA), a cyclic trimethylolpropane formal methacrylate, and tetrahydrofurfuryl methacrylate.

Among those exemplified as above, the monofunctional polymerizable compound (B) is selected from compounds having a glass transition temperature of 10° C. or higher and 90° C. or lower.

Among these, as the monofunctional polymerizable compound (B), it is preferable to use one or more compounds selected from a cyclic trimethylolpropane formal acrylate (CTFA), 3,3,5-trimethylcyclohexyl acrylate (TMCHA), 4-tert-butylcyclohexyl acrylate (TBCHA), and N,N-diethyl acrylamide (DEAA).

In addition, it is also preferable to select the monofunctional polymerizable compound (B) so that the monofunctional polymerizable compound (B) includes one or more compounds selected from the above-described cyclic ether polymerizable compound and the above-described hydrocarbon ring polymerizable compound. In such a case, the curability of the radiation curable ink composition for ink jet may be improved.

In addition, in a case where a cyclic ether polymerizable compound is selected as the monofunctional polymerizable compound (B), it is more preferable to select so that the monofunctional polymerizable compound (B) includes the cyclic trimethylolpropane formal acrylate. Further, in a case where a hydrocarbon ring polymerizable compound is selected as the monofunctional polymerizable compound (B), it is more preferable to select the monofunctional polymerizable compound (B) so that the monofunctional polymerizable compound (B) includes 4-tert-butylcyclohexyl acrylate or 3,3,5-trimethylcyclohexyl acrylate. In a case of being selected in such a manner, the curability of the radiation curable ink composition for ink jet and the anti-blocking properties of the coating film thereof may be further improved.

It is noted that one kind of the monofunctional polymerizable compound (B) may be used alone, or two or more kinds thereof may be used in combination.

The content of the monofunctional polymerizable compound (B) is preferably 10% by mass or more, more preferably 15% by mass or more, and still more preferably 20% by mass or more with respect to the total amount of the radiation curable ink composition for ink jet. In a case where the content of the monofunctional polymerizable compound (B) is within the above-described range, the curability of the ink composition is further improved. In addition, the above-described content is preferably 50% by mass or less, more preferably 45% by mass or less, and still more preferably 40% by mass or less. In a case where the content of the monofunctional polymerizable compound (B) is at this level, the curability of the composition and the anti-blocking properties of the coating film can be further improved.

### 1.3. Polymeric Thioxanthone Polymerization Initiator (C)

The radiation curable ink composition for ink jet according to the present embodiment contains a polymeric thioxanthone polymerization initiator (C). In the present specification, the term “polymer” refers to a polymer having a molecular weight of 500 or more.

The polymeric thioxanthone polymerization initiator (C) has an action of generating an active species by irradiation with actinic rays such as ultraviolet rays and visible light, initiating polymerization, and curing the radiation curable ink composition. By using ultraviolet rays (UV) as the actinic rays, it is possible to achieve excellent safety and reduce the cost of the light source lamp.

The molecular weight of the polymeric thioxanthone polymerization initiator (C) is preferably 500 or more and 2,500 or less, more preferably 600 or more and 2,000 or less, and still more preferably 1,000 or more and 2,000 or less.

It is noted that the molecular weight of the polymeric thioxanthone polymerization initiator (C) refers to the molecular weight of the polymeric thioxanthone polymerization initiator (C) in a case where the polymeric thioxanthone polymerization initiator (C) is a pure substance, and it is a weight average molecular weight that is measured by GPC or the like in a case where the polymeric thioxanthone polymerization initiator (C) has a molecular weight distribution.

The content of the polymeric thioxanthone polymerization initiator (C) is preferably 0.1% by mass or more and 10% by mass or less, more preferably 0.5% by mass or more and 5% by mass or less, and still more preferably 1.0% by mass or more and 3.5% by mass or less, with respect to the total amount of the radiation curable ink composition for ink jet. In a case where the content of the polymeric thioxanthone polymerization initiator is within the above-described range, the volatilization of the unreacted polymerizable compound and the decomposition product of the polymerization initiator is suppressed, which makes it possible to reduce the odor.

Examples of the polymeric thioxanthone polymerization initiator (C) include 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane (CAS: 1003567-83-6) and α-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl) (CAS: 813452-37-8).

Examples of the commercially available product of the polymeric thioxanthone polymerization initiator (C) include SpeedCure (registered trademark) 7010 (1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane) (product name, manufactured by Sartomer Company Inc.), and Omnipol (registered trademark) TX (α-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl)) (product name, manufactured by IGM RESINS), Genopol TX-2 (product name, manufactured by RAHN AG).

It is preferable that, among the above-described commercially available products, the polymeric thioxanthone polymerization initiator (C) includes at least one of Omnipol (registered trademark) TX and SpeedCure (registered trademark) 7010.

In other words, it is more preferable that the polymeric thioxanthone polymerization initiator (C) includes one or more compounds selected from 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane and α-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl). In such a case, the volatilization of the unreacted polymerizable compound and the decomposition product of the polymerization initiator is suppressed, which makes it easier to reduce odors.

It is noted that although the polymeric thioxanthone polymerization initiator (C) is involved in the odor and curability of the radiation curable ink composition for ink jet, it does not necessarily exhibit an effect alone, and the odor and curability of the radiation curable ink composition for ink jet change depending on the combination of the polymeric thioxanthone polymerization initiator (C) with the polymerizable compound, the polymerization inhibitor, the polymerization promoter, and the like.

### 1.4. Other Components

The radiation curable ink composition for ink jet according to the present embodiment may contain components other than the above-described components, which are as described below.

1.4.1. Polymerizable Compound Other than Those Described Above

The polymerizable compound that may be contained in the radiation curable ink composition for ink jet is not particularly limited as long as it is a compound having a property of being polymerized by a polymerization initiator, and examples thereof include a polymerizable compound other than the above-described hydroxyl group-containing polymerizable compound (A) or monofunctional polymerizable compound (B). Examples of such a polymerizable compound include various monomers and oligomers, which are monofunctional or di- or higher functional.

Examples of such a polymerizable compound include unsaturated carboxylic acids such as (meth)acrylic acid, itaconic acid, crotonic acid, isocrotonic acid, and maleic acid, and salts or esters thereof, urethane, an amide and an anhydride thereof, acrylonitrile, styrene, and various unsaturated polyesters, unsaturated polyethers, unsaturated polyamides, and unsaturated urethanes.

In addition, examples of the oligomer include an oligomer formed from the above-described monomer, such as a linear (meth)acrylic oligomer, an epoxy (meth)acrylate, an oxetane (meth)acrylate, an aliphatic urethane (meth)acrylate, an aromatic urethane (meth)acrylate, and a polyester (meth)acrylate.

In the present specification, the term “oligomer” refers to a dimeric or more oligomeric polymer that is obtained by polymerizing a monomer, where the polymer has a weight average molecular weight of 10,000 or less. It is noted that a value obtained by measurement using a mass analysis method is employed as the weight average molecular weight in the present specification.

The radiation curable ink composition for ink jet may contain an N-vinyl compound as a monofunctional monomer or a polyfunctional monomer. Examples of N-vinyl compounds include N-vinylcarbazole, N-vinylcaprolactam, and N-vinyl methyl oxazolidinone (VMOX), as well as dimethyl acrylamide, dimethylaminopropyl acrylamide, and derivatives thereof.

The radiation curable ink composition for ink jet according to the present embodiment may contain as a polyfunctional monomer, vinyl ether group-containing (meth)acrylic acid esters represented by General Formula (I).

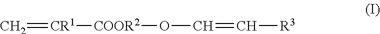

(In Formula (I), R¹ is a hydrogen atom or a methyl group, R² is a divalent organic residue having 2 to 20 carbon atoms, and R³ is a hydrogen atom or a monovalent organic residue having 1 to 11 carbon atoms.)

Specific examples of such a compound include (meth)acrylic acid 2-vinyloxyethyl ester, (meth)acrylic acid 3-vinyloxypropyl ester, (meth)acrylic acid 1-methyl-2-vinyloxyethyl ester, acrylic acid 2-(2-vinyloxyethoxy)ethyl ester (VEEA), methacrylic acid 2-(2-vinyloxyethoxy)ethyl ester, (meth)acrylic acid 2-vinyloxypropyl ester, (meth)acrylic acid 4-vinyloxybutyl ester, (meth)acrylic acid 1-methyl-3-vinyloxypropyl ester, (meth)acrylic acid 1-vinyloxymethylpropyl ester, (meth)acrylic acid 2-methyl-3-vinyloxypropyl ester, (meth)acrylic acid 1,1-dimethyl-2-vinyloxyethyl ester, (meth)acrylic acid 3-vinyloxybutyl ester, (meth)acrylic acid 1-methyl-2-vinyloxypropyl ester, (meth)acrylic acid 2-vinyloxybutyl ester, (meth)acrylic acid 4-vinyloxycyclohexyl ester, (meth)acrylic acid 6-vinyloxyhexyl ester, (meth)acrylic acid 4-vinyloxymethylcyclohexylmethyl ester, (meth)acrylic acid 3-vinyloxymethylcyclohexylmethyl ester, (meth)acrylic acid 2-vinyloxymethylcyclohexylmethyl ester, (meth)acrylic acid p-vinyloxymethylphenylmethyl ester, (meth)acrylic acid m-vinyloxymethylphenylmethyl ester, (meth)acrylic acid o-vinyloxymethylphenylmethyl ester, (meth)acrylic acid 2-(vinyloxyethoxy)ethyl ester, (meth)acrylic acid 2-(vinyloxyisopropoxy)ethyl ester, (meth)acrylic acid 2-(vinyloxyethoxy)propyl ester, (meth)acrylic acid 2-(2-vinyloxyethoxy)isopropyl ester, (meth)acrylic acid 2-(vinyloxyisopropoxy)propyl ester, (meth)acrylic acid 2-(vinyloxyisopropoxy)isopropyl ester, (meth)acrylic acid 2-(vinyloxyethoxyethoxy)ethyl ester, (meth)acrylic acid 2-(vinyloxyethoxyisopropoxy)ethyl ester, (meth)acrylic acid 2-(vinyloxyisopropoxyethoxy)ethyl ester, (meth)acrylic acid 2-(vinyloxyisopropoxyisopropoxy)ethyl ester, (meth)acrylic acid 2-(vinyloxyethoxyethoxy)propyl ester, (meth)acrylic acid 2-(vinyloxyethoxyisopropoxy)propyl ester, (meth)acrylic acid 2-(vinyloxyisopropoxyethoxy)propyl ester, (meth)acrylic acid 2-(vinyloxyisopropoxyisopropoxy)propyl ester, (meth)acrylic acid 2-(vinyloxyethoxyethoxy)isopropyl ester, (meth)acrylic acid 2-(vinyloxyethoxyisopropoxy)isopropyl ester, (meth)acrylic acid 2-(vinyloxyisopropoxyethoxy)isopropyl ester, (meth)acrylic acid 2-(vinyloxyisopropoxyisopropoxy)isopropyl ester, (meth)acrylic acid 2-(vinyloxyethoxyethoxyethoxy)ethyl ester, (meth)acrylic acid 2-(vinyloxyethoxyethoxyethoxyethoxyethoxy)ethyl ester, (meth)acrylic acid 2-(isopropenoxyethoxy)ethyl ester, (meth)acrylic acid 2-(isopropenoxyethoxyethoxy)ethyl ester, (meth)acrylic acid 2-(isopropenoxyethoxyethoxyethoxy)ethyl ester, (meth)acrylic acid 2-(isopropenoxyethoxyethoxyethoxyethoxy)ethyl ester, (meth)acrylic acid polyethylene glycol monovinyl ether ester, and (meth)acrylic acid polypropylene glycol monovinyl ether ester.

In addition, the radiation curable ink composition for ink jet may contain a compound that belongs to a glycol-based di(meth)acrylate. Examples of such a compound include ethylene glycol di(meth)acrylate, diethylene glycol di(meth)acrylate, triethylene glycol di(meth)acrylate, propylene glycol di(meth)acrylate, dipropylene glycol diacrylate (DPGDA), dipropylene glycol dimethacrylate, tripropylene glycol diacrylate (TPGDA), tripropylene glycol dimethacrylate, 1,4-butanediol di(meth)acrylate, 1,3-butanediol di(meth)acrylate, dibutylene glycol di(meth)acrylate, tributylene glycol di(meth)acrylate, tetrabutylene glycol di(meth)acrylate, 1,5-pentanediol di(meth)acrylate, 1,4-pentanediol di(meth)acrylate, 1,3-pentanediol di(meth)acrylate, dipentylene glycol di(meth)acrylate, tripentylene glycol di(meth)acrylate, cyclopentanediol di(meth)acrylate, and neopentyl glycol di(meth)acrylate.

In addition, the radiation curable ink composition for ink jet may contain a (meth)acrylate having an aromatic ring skeleton. Examples of the (meth)acrylate compound having an aromatic ring skeleton include phenoxyethyl acrylate (PEA), phenoxyethyl methacrylate, 2-hydroxy-3-phenoxypropyl (meth)acrylate, benzyl (meth)acrylate, phenoxydiethylene glycol (meth)acrylate, nonylphenoxyethyl (meth)acrylate, and an alkoxylated phenoxyethyl (meth)acrylate.

Further, the radiation curable ink composition for ink jet may contain N-methacryloylmorpholine, 1-acryloylpyrrolidin-2-one, 1-methacryloylpyrrolidin-2-one, 1-acryloylpiperidin-2-one, 1-methacryloylpiperidin-2-one, 2-hydroxy-3-phenoxypropyl (meth)acrylate, a cyclic trimethylolpropane formal (meth)acrylate, (2-methyl-2-ethyl-1,3-dioxolan-4-yl)methyl (meth)acrylate (MEDOL-10 (product name)), hydroxyethyl acrylamide (HEAA), hydroxyethyl methacrylamide, dimethylaminopropyl acrylamide (DMAPAA), dimethylaminopropyl methacrylamide, or a derivative thereof.

The radiation curable ink composition for ink jet according to the present embodiment may contain an amine-modified oligomer as a polymerizable compound. However, from the viewpoint of improving ejection stability without increasing the viscosity of the radiation curable ink composition for ink jet, it is preferable that the radiation curable ink composition for ink jet does not contain an amine-modified oligomer or contain an amine-modified oligomer such that the content thereof does not exceed 5% by mass. In addition, in a case where the amine-modified oligomer is contained, the content of the amine-modified oligomer is preferably more than 0% by mass and less than 5% by mass with respect to the total amount of the ink composition.

The amine-modified oligomer improves the curability of the radiation curable ink composition for ink jet, whereas in a case where the content thereof exceeds 5% by mass, the viscosity increases, and the ejection stability during ink jet recording tends to deteriorate.

The amine-modified oligomer is an oligomer having one or more amino groups in the molecule. The amine-modified oligomer may contain one or more functional groups other than the amino group, and it preferably contains two or more functional groups other than the amino group.

Examples of the amine-modified oligomer include an amine-modified (meth)acrylate oligomer.

The content of the amine-modified oligomer is preferably less than 5% by mass, more preferably less than 3% by mass, still more preferably less than 2% by mass, particularly preferably less than 1% by mass, more particularly preferably less than 0.5% by mass, and still more particularly preferably 0% by mass, with respect to the total amount of the ink composition. In a case where the content of the amine-modified oligomer is less than 5% by mass, the curability can be improved without increasing the viscosity of the radiation curable ink composition for ink jet.

Examples of the commercially available product of the amine-modified oligomer include CN371 NS, CN373, CN374, CN383, CN386, CN550, and CN551 (product names, all of which are manufactured by Sartomer Company Inc.), PHOTOMER (registered trademark) 4771, PHOTOMER 4250, and PHOTOMER 4068 (all of which are manufactured by IGM RESINS), EBECRYL (registered trademark) 80, EBECRYL 7100, and EBECRYL P115 (all of which are manufactured by DAICEL-ALLNEX LTD.), and LAROMER (registered trademark) PO 77F, LAROMER PO 8996, and LAROMER PO 94F (all of which are manufactured by BASF SE).

It is noted that although the amine-modified oligomer has a strong property of contributing to the curability and viscosity of the radiation curable ink composition for ink jet, it does not necessarily contribute alone, and the properties of the radiation curable ink composition for ink jet and the cured product thereof change depending on the combination of the amine-modified oligomer with other polymerizable compounds.

The radiation curable ink composition for ink jet according to the present embodiment may contain a urethane oligomer as a polymerizable compound; however, from the viewpoint of improving ejection stability without increasing the viscosity of the radiation curable ink composition for ink jet, it is preferable that the urethane oligomer is contained such that the content of the urethane oligomer does not exceed 5% by mass with respect to the total amount of the ink composition.

The urethane oligomer tends to increase the viscosity of the ink composition, and it is used to maintain a good balance of physical properties. The content of the urethane oligomer is preferably 5% by mass or less, more preferably less than 5% by mass, and still more preferably less than 3% by mass, with respect to the total amount of the polymerizable compound.

Examples of the urethane oligomer include a urethane (meth)acrylate oligomer.

Examples of the commercially available product of the urethane oligomer include CN991 NS, CN996 NS, CN9002, CN9010 NS, and CN9013 NS (product names, all of which are manufactured by Sartomer Company Inc.), New Frontier R-1235, R-1220, R-1304, R-1214, R-1302XT, and R-1603 (product names, all of which are manufactured by DKS Co., Ltd.), and Quick Cure (registered trademark) (manufactured by KJ Chemicals Corporation).

Regarding the exemplified polymerizable compounds (monomers and/or oligomers), one kind thereof may be used alone, or two or more kinds thereof may be used in combination. The lower limit of the total content of all of the polymerizable compounds contained in the radiation curable ink composition for ink jet is not limited: However, with respect to the total mass (100% by mass) of the ink composition, the lower limit thereof is 30.0% by mass or more, preferably 50.0% by mass or more, more preferably 60.0% by mass or more, and still more preferably 70.0% by mass or more. In addition, the upper limit of the total content of the polymerizable compound is not limited: However, with respect to the total mass (100% by mass) of the ink composition, the upper limit thereof is 95.0% by mass or less, preferably 90.0% by mass or less, more preferably 85.0% by mass or less, and still more preferably 80.0% by mass or less.

### 1.4.2. Blending of Polymerizable Compound

The radiation curable ink composition for ink jet according to the present embodiment may contain the polymerizable compound described in “1.4.1. Polymerizable Compound Other Than Those Described Above” in addition to the hydroxyl group-containing polymerizable compound (A) and the monofunctional polymerizable compound (B); however, there is a suitable range for the blending thereof as follows.

In the radiation curable ink composition for ink jet according to the present embodiment, the weighted average of the glass transition temperature of the polymerizable compound to be contained is more preferably 30° C. or higher and 70° C. or lower, and still more preferably 35° C. or higher and 65° C. or lower.

Here, “the weighted average of the glass transition temperature of the polymerizable compound to be contained” is determined as follows. The glass transition temperature of each polymerizable compound contained in the radiation curable ink composition for ink jet is the glass transition temperature of each homopolymer of each polymerizable compound. In addition, a temperature obtained by proportionally dividing the glass transition temperature of each polymerizable compound at a proportion of the mass to be contained is defined as “the weighted average of the glass transition temperature of the polymerizable compound to be contained”. That is, “the weighted average of the glass transition temperature of the polymerizable compound to be contained” is defined as a value calculated by setting the total mass of all of the polymerizable compounds contained in the radiation curable ink composition for ink jet to 100% by mass and weighting the glass transition temperature of each polymerizable compound according to the proportion (% by mass) occupied by each polymerizable compound.

Here, a calculation method for the weighted average of the glass transition temperature in the polymerizable compound will be described. The value of the weighted average of the glass transition temperature is denoted as Tg_{A11}, the glass transition temperature of the homopolymer of each polymerizable compound is denoted as Tg_{N}, and the mass ratio of the polymerizable compound is denoted as X_{N} (wt %). For the number N, numbers are entered in order starting from 1, depending on the kind of the polymerizable compound contained in the radiation curable ink composition for ink jet. For example, in a case where three kinds of polymerizable compounds are used, Tg₁, Tg₂, and Tg₃ are generated. The weighted average Tg_{A11} of the glass transition temperature of the homopolymer is the sum of the products of the glass transition temperature Tg_{N} of the homopolymer calculated for each polymerizable compound and the mass ratio X_{N} of the monomer. As a result, Expression (1) is established.

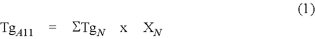

In a case where the weighted average of the glass transition temperature of the polymerizable compound to be contained is 30° C. or higher and 70° C. or lower, a recorded matter having further excellent blocking properties and shrinkage characteristics is further easily obtained. As the glass transition temperature is higher, the coating film and the recording medium are less likely to stick, and thus the blocking properties are excellent. In addition, as the glass transition temperature is lower, the flexibility of the coating film is increased, and the shrinkage characteristics are excellent.

In addition, in the radiation curable ink composition for ink jet according to the present embodiment, the monofunctional polymerizable compound is contained such that the content thereof is preferably 50% by mass or more, more preferably 55% by mass or more, and still more preferably 60% by mass or more, with respect to the total mass of the polymerizable compound to be contained. In such a case, the curability of the composition and the anti-blocking properties of the coating film can be further improved.

Further, it is more preferable that the radiation curable ink composition for ink jet contains a compound having a nitrogen-containing heterocyclic structure as a polymerizable compound having a glass transition temperature of higher than 90° C. Examples of the compound having a nitrogen-containing heterocyclic structure having a glass transition temperature of higher than 90° C. include acryloyl morpholine (ACMO) and N-vinyl methyl oxazolidinone (VMOX). In such a case, the anti-blocking properties of the coating film can be further improved. In a case where a polymerizable compound having a glass transition temperature of higher than 90° C. is contained, the weighted average of the glass transition temperature of the polymerizable compound to be contained increases, and the blocking properties are excellent. Further, in a case where a compound having a nitrogen-containing heterocyclic structure is contained, the curability of the coating film is also excellent. The content of the nitrogen-containing heterocyclic compound is preferably 5% by mass or more and 60% by mass or less, more preferably 12.5% by mass or more and 50% by mass or less, still more preferably 15% by mass or more and 45% by mass or less, and even still more preferably 20% by mass or more and 40% by mass or less, with respect to the total amount of the ink composition. In a case where the content of the nitrogen-containing heterocyclic compound is in the above-described range, the curability and adhesiveness of the ink composition tend to be excellent.

Further, in a case where the radiation curable ink composition for ink jet contains a polymerizable compound having a glass transition temperature of higher than 90° C., the content thereof is preferably 5% by mass or more and 55% by mass or less, more preferably 10% by mass or more and 50% by mass or less, still more preferably 15% by mass or more and 45% by mass or less, and even still more preferably 20% by mass or more and 40% by mass or less, with respect to the total amount of the composition. In such a case, the anti-blocking properties of the coating film can be further improved.

### 1.4.3. Coloring Material

The radiation curable ink composition for ink jet according to the present embodiment may contain a coloring material. In a case of containing a coloring material, the radiation curable ink composition for ink jet according to the present embodiment can be used as a colored ink composition.

The content of the coloring material is preferably 0.1% by mass or more and 10.0% by mass or less, more preferably 0.5% by mass or more and 5.0% by mass or less, with respect to the total amount of the ink composition. It is noted that the radiation curable ink composition for ink jet according to the present embodiment may be used as a clear ink that does not contain a coloring material or contains a coloring material to an extent that is not intended for coloring. The content to an extent that is not intended for coloring is, for example, 0.1% by mass or less with respect to the total amount of the ink composition.

As the coloring material, a pigment is preferably used. In a case where a pigment is used, a pigment dispersion liquid may be prepared in advance, and the pigment dispersion liquid may be used in the ink composition. In order to disperse a polymerizable compound or a pigment, the pigment dispersion liquid may contain a dispersing agent or the like, which will be described later. Any of an inorganic pigment or an organic pigment may be used as the pigment.

Examples of the inorganic pigment include carbon blacks (C. I. Pigment Black 7) such as furnace black, lamp black, acetylene black, and channel black, iron oxide, and titanium oxide.

Examples of the organic pigments include azo pigments such as an insoluble azo pigment, a condensed azo pigment, an azo lake, and a chelate azo pigment, polycyclic pigments such as a phthalocyanine pigment, perylene and perinone pigments, an anthraquinone pigment, a quinacridone pigment, a dioxane pigment, a thioindigo pigment, an isoindolinone pigment, and a quinophthalone pigment, dye chelates (for example, a basic dye-type chelate, an acid dye-type chelate, and the like), dye lakes (a basic dye-type lake and an acid dye-type lake), a nitro pigment, a nitroso pigment, carbon black, aniline black, and a daylight fluorescent pigment.

Examples of the black pigment include No. 2300, No. 900, MCF 88, No. 33, No. 40, No. 45, No. 52, MA7, MA8, MA100, and No. 2200 B (product names, all of which are manufactured by Mitsubishi Chemical Corporation), Raven 5750, Raven 5250, Raven 5000, Raven 3500, Raven 1255, and Raven 700 (all of which are manufactured by Columbia Carbon Inc.), Regal 400R, Regal 330R, Regal 660R, Mogul (registered trademark) L, Monarch (registered trademark) 700, Monarch 800, Monarch 880, Monarch 900, Monarch 1000, Monarch 1100, Monarch 1300, and Monarch 1400 (product names, all of which are manufactured by Cabot JAPAN K.K.), Color Black FW1, Color Black FW2, Color Black FW2V, Color Black FW18, Color Black FW200, Color Black S150, Color Black S160, Color Black S170, Printex (registered trademark) 35, Printex U, Printex V, Printex 140U, Special Black 6, Special Black 5, Special Black 4A, and Special Black 4 (product names, all of which are manufactured by Degussa).

Examples of the white pigment include C.I. Pigment White 6, 18, and 21, a metal oxide, a metal compound such as barium sulfate or calcium carbonate. Examples of the metal oxide include titanium dioxide, zinc oxide, silica, alumina, and magnesium oxide.

Examples of the yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and 185.

Examples of the magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of the cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

In addition, examples of the color pigment other than magenta, cyan, and yellow include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Regarding the above-described pigments, one kind thereof may be used alone, or two or more kinds thereof may be used in combination.

### 1.4.4. Dispersing Agent

In a case where the radiation curable ink composition for ink jet according to the present embodiment contains a pigment, a dispersing agent may be further contained in order to further improve the pigment dispersibility. One kind of dispersing agent may be used alone, or two or more kinds thereof may be used in combination.

The dispersing agent is not particularly limited; however, examples thereof include a dispersing agent that is commonly used to prepare a pigment dispersion liquid, such as a polymer dispersing agent. Specific examples of the dispersing agent include those containing, as a main component, one or more of a polyoxyalkylene polyalkylene polyamine, a vinyl-based polymer and a vinyl-based copolymer, an acrylic polymer and an acrylic copolymer, a polyester, a polyamide, a polyimide, a polyurethane, an amino-based polymer, a silicon-containing polymer, a sulfur-containing polymer, a fluorine-containing polymer, and an epoxy resin.

Examples of the commercially available product of the polymer dispersing agent include the AJISPER series manufactured by Ajinomoto Fine-Techno Co., Inc., the Solsperse series (Solsperse 36000 or the like) available from Avecia, Noveon, Lubrizol Corporation or the like, the DISPERBYK series manufactured by BYK Additives & Instruments, and the DISPARLON series manufactured by Kusumoto Chemicals, Ltd.

The content of the dispersing agent is preferably 0.01% by mass or more and 1.0% by mass or less, and more preferably 0.1% by mass or more and 0.5% by mass or less, with respect to the total amount of the ink composition.

### 1.4.5. Polymerization Inhibitor

The radiation curable ink composition for ink jet according to the present embodiment may contain a polymerization inhibitor. One kind of polymerization inhibitor may be used alone, or two or more kinds thereof may be used in combination.

Although the polymerization inhibitor is not limited to the following polymerization inhibitors, examples thereof include p-methoxyphenol, hydroquinone monomethyl ether (MEHQ), 4-hydroxy-2,2,6,6-tetramethylpiperidin-N-oxyl, hydroquinone, cresol, tert-butylcatechol, 3,5-di-tert-butyl-4-hydroxytoluene, 2,2′-methylenebis (4-methyl-6-tert-butylphenol), 2,2′-methylenebis(4-ethyl-6-butylphenol), 4,4′-thiobis(3-methyl-6-tert-butylphenol), and a hindered amine compound.

In addition, examples of the commercially available product of the polymerization inhibitor include ADEKA STAB LA-7RD (2,2,6,6-tetramethyl-4-hydroxypiperidin-1-oxyl), LA-52, LA-57, LA-62, LA-63P, LA-68LD, LA-77Y, LA-77G, LA-81, LA-82 (1,2,2,6,6-pentamethyl-4-piperidyl methacrylate), and LA-87 (product name, all of which are manufactured by ADEKA Corporation), IRGASTAB UV 10 (4,4′-[1, 10-dioxo-1, 10-decanediyl]bis(oxy)bis[2,2,6,6-tetramethyl]-1-piperidinyl oxy) (CAS. 2516-92-9), TINUVIN 123 (4-hydroxy-2,2,6,6-tetramethylpiperidin-N-oxyl), TINUVIN 111FDL, TINUVIN 144, TINUVIN 152, TINUVIN 292, TINUVIN 765, TINUVIN 770DF, TINUVIN 5100, SANOL LS-2626, CHIMASSORB 119FL, CHIMASSORB 2020 FDL, CHIMASSORB 944 FDL, and TINUVIN 622 LD (product name, all of which are manufactured by BASF SE), and FA-711HM, FA-712HM (2,2,6,6-tetramethylpiperidinyl methacrylate, product name, manufactured by Hitachi Chemical Co., Ltd.).

The content of the polymerization inhibitor is preferably 0.01% by mass or more and 1.0% by mass or less and more preferably 0.1% by mass or more and 0.5% by mass or less with respect to the total amount of the ink composition.

### 1.4.6. Slip Agent (Surfactant)

The radiation curable ink composition for ink jet according to the present embodiment may further contain a slip agent. One kind of slip agent may be used alone, or two or more kinds thereof may be used in combination.

The slip agent is preferably a silicone-based surfactant, and more preferably a polyester-modified silicone or a polyether-modified silicone. Examples of the polyether-modified silicone include BYK-378, 3455, BYK-UV3500, 3510, and 3530 (all of which are manufactured by BYK Additives & Instruments), and examples of the polyester-modified silicone include BYK-3570 (manufactured by BYK Additives & Instruments).

The content of the slip agent is preferably 0.1% by mass or more and 1.0% by mass or less and more preferably 0.3% by mass or more and 0.8% by mass or less with respect to the total amount of the ink composition.

### 1.4.7. Photosensitizing Agent

The radiation curable ink composition for ink jet according to the present embodiment may further contain a photosensitizing agent. Examples of the photosensitizing agent include an amine compound (an aliphatic amine, an amine containing an aromatic group, piperidine, a reaction product of an epoxy resin and an amine, triethanolamine triacrylate, or the like), a urea compound (allylthiourea, o-trithiourea, or the like), a sulfur compound (sodium diethyldithiophosphate, a soluble salt of an aromatic sulfinic acid, or the like), a nitrile-based compound (N,N-diethyl-p-aminobenzonitrile or the like), a phosphorus compound (tri-n-butylphosphine, sodium diethyldithiophosphide, or the like), a nitrogen compound (a Michler's ketone, an N-nitrosohydroxylamine derivative, an oxazolidine compound, a tetrahydro-1,3-oxazine compound, a condensation product between formaldehyde or acetaldehyde and a diamine, or the like), and a chlorine compound (carbon tetrachloride, hexachloroethane, or the like).

### 1.5. Physical Properties

The viscosity of the radiation curable ink composition for ink jet according to the present embodiment at 20° C. is preferably less than 25 mPa·s, more preferably 15 mPa·s or more and less than 20 mPa·s, and still more preferably less than 15 mPa·s. In a case where the viscosity of the ink composition at 20° C. is within the above-described range, an amount of the ink composition can be ejected from the nozzle, and thus the ink composition can be suitably used in the ink jet recording apparatus. It is noted that regarding the measurement of the viscosity, the viscosity can be measured by increasing the Shear Rate from 10 [s⁻¹] to 1,000 [s⁻¹] and reading a viscosity at a Shear Rate at 200 hours by using a viscoelasticity tester MCR-301 (manufactured by Anton Paar GmbH) in an environment of 20° C.

### 1.6. Action And Effect And Like

The radiation curable ink composition for ink jet according to the present embodiment contains the hydroxyl group-containing polymerizable compound (A) and the polymeric thioxanthone polymerization initiator (C) as a polymerization initiator, and thus the odor of the composition can be reduced, and the curability is also improved. In addition, the radiation curable ink composition for ink jet according to the present embodiment contains the monofunctional polymerizable compound (B) having a glass transition temperature of 10° C. or higher and 90° C. or lower, and thus it is possible to suppress the decrease in the blocking properties (and/or adhesiveness to the recording medium) of the coating film, which occurs since the radiation curable ink composition for ink jet contains the hydroxyl group-containing polymerizable compound (A) having a relatively low glass transition temperature.

### 2. Ink Jet Recording Method

Next, an ink jet recording method that uses the above-described radiation curable ink composition for ink jet will be described. Examples of such an ink jet recording method include a method including an ejection step of ejecting the above-described radiation curable ink composition for ink jet from an ink jet head to adhere the radiation curable ink composition for ink jet to a recording medium, and an irradiation step of irradiating the radiation curable ink composition for ink jet which is adhered to the recording medium, with actinic rays. Hereinafter, each step of the ink jet recording method and the recording medium that is used in the ink jet recording method will be described.

### 2.1. Ejection Step

In the ejection step, the ink composition is made into liquid droplets having a fine particle diameter and ejected from the ink jet head onto the recording medium.

As the ink jet head that is used in the ejection step, there are a line head that is used in a line method and a serial head that is used in a serial method.

In the case of the line method, an ink jet head (line head) having a width equal to or larger than a recording width of the recording medium is mounted on the recording apparatus, and an image is recorded on the recording medium by ejecting the ink composition while relatively moving positions of the line head and the recording medium with each other in a scanning direction (the longitudinal direction or the transport direction of the recording medium) intersecting a width direction of the recording medium.

In the case of the serial method, an ink jet head (serial head) is mounted on a carriage that is movable in the width direction of the recording medium, and an image is recorded on the recording medium by ejecting the ink composition while moving the carriage along the main scanning direction (the lateral direction or the width direction of the recording medium).

### 2.2. Irradiation Step

In the irradiation step, the radiation curable ink composition for ink jet, which is adhered to the recording medium, is irradiated with actinic rays. By the irradiation with actinic rays, the polymerizable compound in the ink composition starts to undergo a polymerization reaction and then undergoes curing, thereby forming a coating film.

Since a polymerization initiator is contained in the ink composition, in a case where the ink composition is irradiated with actinic rays, the polymerization initiator undergoes excitation and cleavage, thereby generating radicals and acids. The polymerization reaction of the monomer is promoted by the generated radicals and the like.

Examples of the actinic rays include ultraviolet rays, infrared rays, visible light, and X-rays. In a case where ultraviolet rays are used as the actinic rays, for example, a light emitting diode (UV-LED), a laser diode (LD), a high-pressure mercury lamp, a metal halide lamp, or the like can be used as the light source. In a case where a UV-LED or an LD is used, the wavelength of the actinic ray to be emitted is preferably 200.0 nm or more and 430.0 nm or less.

In the irradiation step, the irradiation energy of the actinic rays to be emitted in one time is preferably 150 mJ/cm² or more and less than 250 mJ/cm², and more preferably less than 150 mJ/cm². In a case where the irradiation energy of the actinic rays is in the above-described range, the irradiation of the surface and the entirety of the ink composition can be more efficiently carried out.

### 2.3. Recording Medium

The form of the recording medium that is used in the ink jet recording method is not particularly limited; however, examples thereof include a film shape and a board shape.

The material of the recording medium is not particularly limited; however, examples thereof include resins such as polyvinyl chloride, polyethylene terephthalate, polycarbonate, polystyrene, polyurethane, polyethylene, polypropylene, polyvinyl acetal, cellulose diacetate, cellulose triacetate, cellulose propionate, cellulose butyrate, cellulose acetate butyrate, and nitrocellulose, metals such as iron, silver, copper, and aluminum, and glass.

### 3. Recording Apparatus

A recording apparatus according to the present embodiment includes the above-described radiation curable ink composition for ink jet, and a head that ejects the radiation curable ink composition for ink jet.

In the recording apparatus according to the present embodiment, the above-described radiation curable ink composition for ink jet contains the hydroxyl group-containing polymerizable compound (A) and the polymeric thioxanthone polymerization initiator (C) as a polymerization initiator, and thus it is possible to carry out recording with little odor of the composition, and it is also possible to form an image having good curability. In addition, according to the recording apparatus, the above-described radiation curable ink composition for ink jet according to the present embodiment contains the monofunctional polymerizable compound (B) having a glass transition temperature of 10° C. or higher and 90° C. or lower, and thus it is possible to form an image having good blocking properties (and/or adhesiveness to the recording medium) of the coating film that forms an image that is to be obtained.

The recording method according to the present embodiment can be carried out by using the ink jet recording apparatus according to the present embodiment. An example of an ink jet recording apparatus that is capable of carrying out the recording method according to the present embodiment will be described below.

The ink jet recording apparatus according to the present embodiment includes a recording head that adheres a radiation curable ink composition for ink jet to a film-shaped recording medium, an ultraviolet irradiation unit that cures the coating film by irradiating the coating film with ultraviolet rays to form a cured film, and a heating unit that heats the cured film to a temperature that is equal to or higher than the glass transition temperature of the cured film and is equal to or lower than the thermal deformation temperature of the polymer contained in the recording medium.

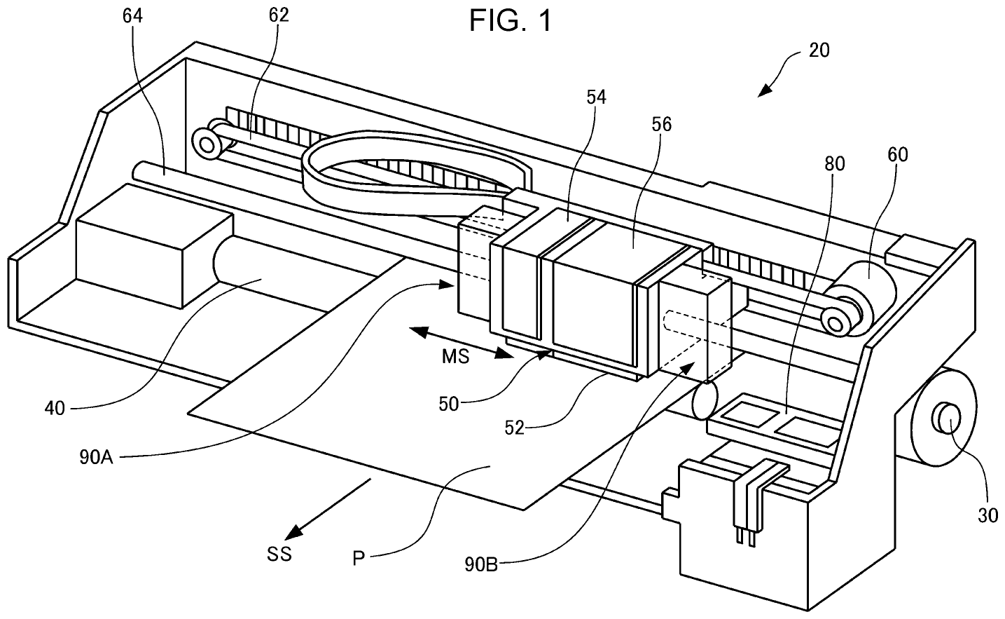

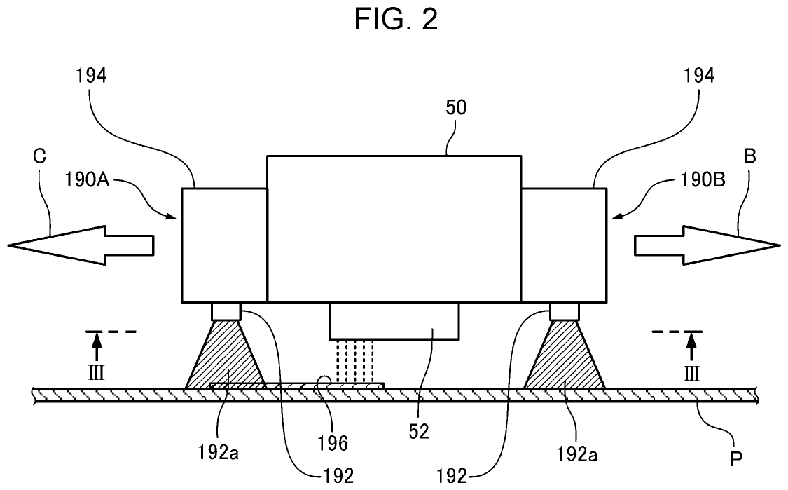

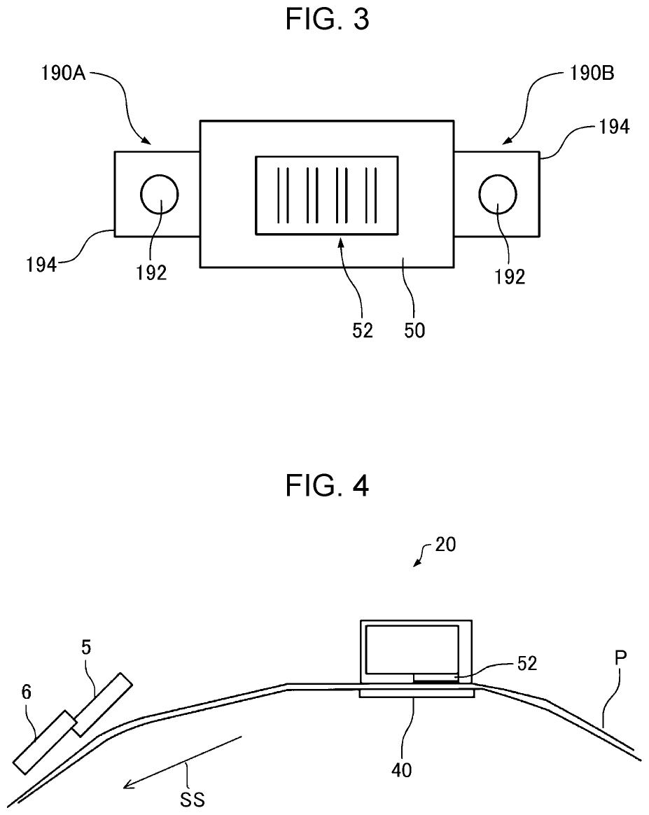

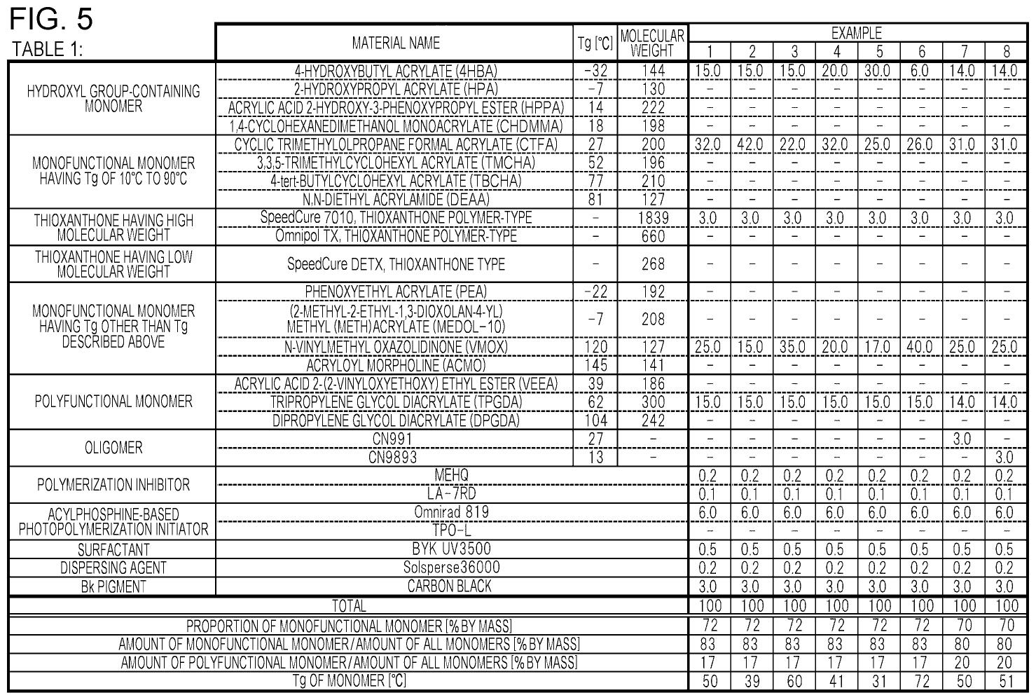

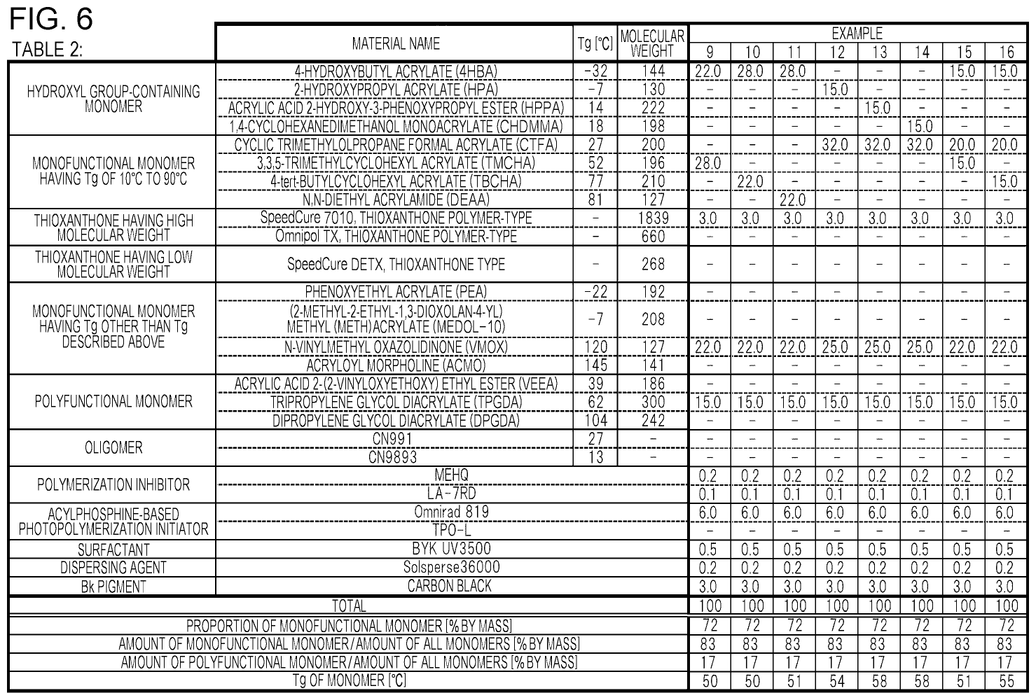

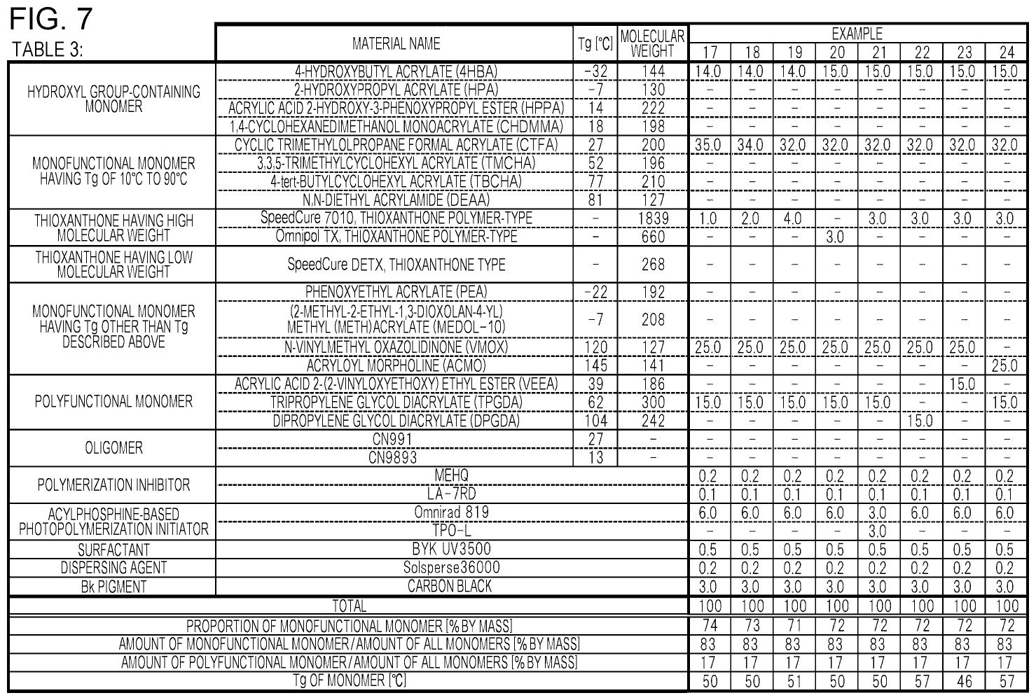

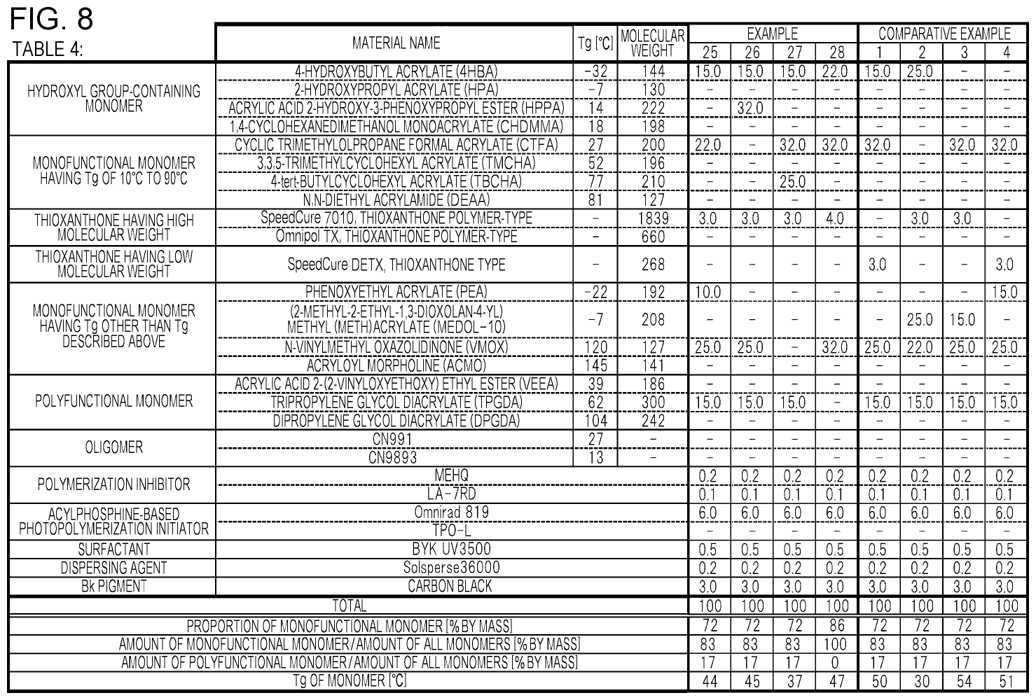

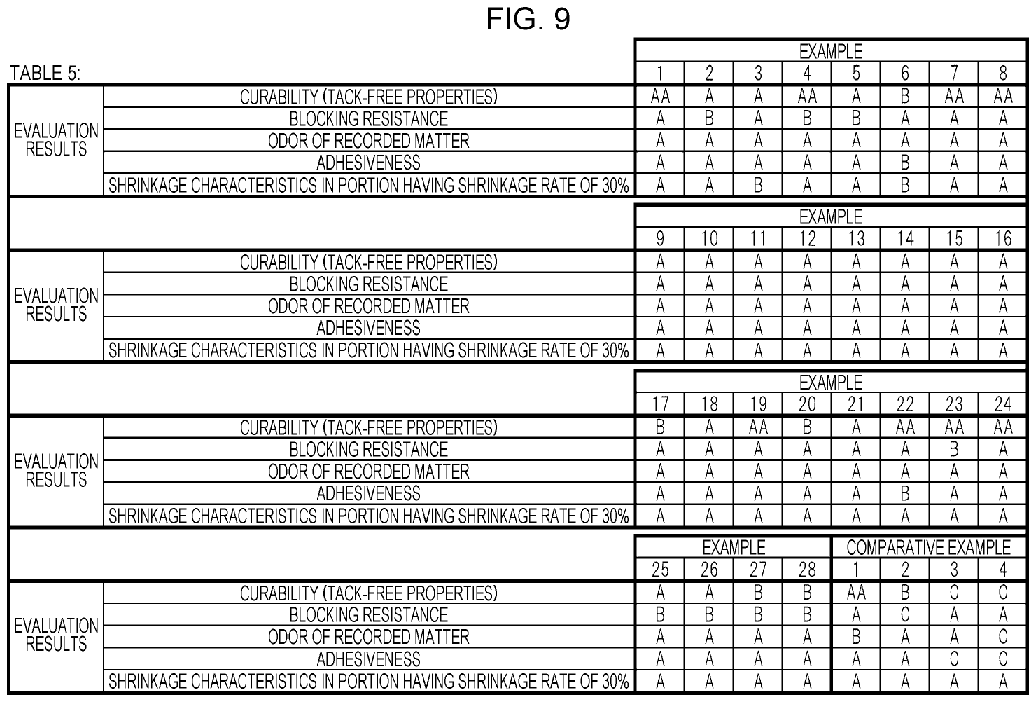

As the ink jet recording apparatus that is used in the recording method according to the present embodiment, for example, an ink jet recording apparatus illustrated in FIG. 1 can be used. FIG. 1 is a perspective view of an ink jet recording apparatus that can be used in the recording method according to the present embodiment. FIG. 2 is a front view of an ultraviolet irradiation apparatus 90A (corresponding to 190A in FIG. 2) or 90B (corresponding to 190B in FIG. 2) illustrated in FIG. 1. FIG. 3 is a view taken in an arrow direction along a line III-III in FIG. 2.

An ink jet recording apparatus 20 illustrated in FIG. 1 includes a motor 30 that sends a recording medium P in a sub-scanning direction SS, a platen 40, a recording head 52 that makes the radiation curable ink composition for ink jet into liquid droplets having a fine particle diameter and then ejects the liquid droplets from the head nozzle to the recording medium P, a carriage 50 on which the recording head 52 is mounted, a carriage motor 60 that moves the carriage 50 in a main scanning direction MS, and a pair of ultraviolet irradiation apparatus 90A and 90B that eject the liquid droplets of the radiation curable ink composition for ink jet from the recording head 52 and then irradiate the liquid droplets adhered onto the recording medium P with ultraviolet rays.

The carriage 50 is pulled by a traction belt 62 that is driven by the carriage motor 60, and then it moves along a guide rail 64.

The recording head 52 is mounted on the carriage 50 and moves in the main scanning direction MS in association with an operation toward a movement direction (hereinafter, also referred to as a “main scanning direction”) MS of the carriage 50.

In addition, the recording head 52 can eject a radiation curable ink composition for ink jet. In the example of FIG. 1, the recording head 52 is a serial type head for full-color printing in which four colors of ink are ejected, where a large number of head nozzles are provided for each color. In addition to the recording head 52, a black color cartridge 54 as a black ink container, which accommodates black ink that is supplied to the recording head 52, and a color ink cartridge 56 as a color ink container, which accommodates color ink that is supplied to the recording head 52, are mounted on the carriage 50 on which such a recording head 52 is mounted. The above-described radiation curable ink composition for ink jet is accommodated in at least one of the cartridge 54 and the cartridge 56.

In the coating film forming step according to the present embodiment, the amount of liquid droplets ejected from the recording head 52 is preferably 1 pl or more and 20 pl or less. In a case where the amount of liquid droplets is within the above-described range, the ejection stability is good, which makes it possible to obtain an image having high image quality.

A capping apparatus 80 for sealing the nozzle surface of the recording head 52 at the time of stopping is provided at a home position (the position on the right side in FIG. 1) of the carriage 50. In a case where the printing job is finished and then the carriage 50 reaches the top of the capping apparatus 80, the capping apparatus 80 is automatically raised by a mechanism (not illustrated in the drawing), and then the nozzle surface of the recording head 52 is sealed. The capping prevents the drying or deterioration of the ink in the nozzle. The positioning control of the carriage 50 is carried out, for example, in order to accurately carry out the positioning of the carriage 50 at a position of the capping apparatus 80.

By using such an ink jet recording apparatus 20, it is possible to eject liquid droplets of the radiation curable ink composition for ink jet onto a recording medium to adhere the liquid droplets to the recording medium and form a coating film. In addition, according to the ink jet recording apparatus 20, the coating film forming step and the curing step can be continuously carried out by one apparatus without carrying out the coating film forming step and the curing step by separate apparatuses.

Examples of the irradiation unit that is capable of carrying out irradiation with ultraviolet rays include the ultraviolet irradiation apparatuses illustrated in FIG. 1 and FIG. 2.

As illustrated in FIG. 1 to FIG. 3, the ultraviolet irradiation apparatuses 190A and 190B are respectively attached to both side ends of the carriage 50 along the movement direction.

As illustrated in FIG. 2, the ultraviolet irradiation apparatus 190A attached to the left side of the recording head 52 carries out ultraviolet irradiation on the liquid droplets ejected onto the recording medium P in a case of right scanning where the carriage 50 moves in the right direction (in the direction of the arrow B in FIG. 2). On the other hand, the ultraviolet irradiation apparatus 190B attached to the right side of the recording head 52 carries out ultraviolet irradiation on the liquid droplets ejected onto the recording medium P in a case of left scanning where the carriage 50 moves in the left direction (in the direction of the arrow C in FIG. 2).

Each of the ultraviolet irradiation apparatuses 190A and 190B includes a housing 194 that is attached to the carriage 50 and supports each ultraviolet light source 192 one by one in an aligned manner; and a light source control circuit (not illustrated in the drawing) that controls the emission of light and the turning off of light in the ultraviolet light source 192. As illustrated in FIG. 2 and FIG. 3, one ultraviolet light source 192 is provided in each of the ultraviolet irradiation apparatuses 190A and 190B; however, two or more ultraviolet light sources 192 may be provided therein. As the ultraviolet light source 192, it is preferable to use any of a light emitting diode (UV-LED) or a laser diode (LD). As a result, as compared with a case where a mercury lamp, a metal halide lamp, or other lamps are used as the ultraviolet light source, it is possible to avoid the ultraviolet light source from being increased in size for equipment of a filter and the like. In addition, the intensity of the ultraviolet rays emitted does not decrease by the absorption by the filter, and thus the radiation curable ink composition for ink jet can be efficiently cured.

In addition, the wavelengths of the light emitted from the respective ultraviolet light sources 192 may be the same or different from each other. In a case where an LED or an LD is used as the ultraviolet light source 192, the wavelength of the emitted ultraviolet rays may be any wavelength in a range of approximately 350.0 nm or more and 430.0 nm or less.

According to the ultraviolet irradiation apparatuses 190A and 190B, as illustrated in FIG. 2, the liquid droplets adhered onto the recording medium P by the ejection from the recording head 52 are irradiated with an ultraviolet ray 192a by the ultraviolet light source 192 that irradiates the top of the recording medium P in the vicinity of the recording head 52, at least the surface of the liquid droplets is cured, whereby it is possible to form an image on the recording medium.

Hereinafter, a method of forming an image in a desired region by repeating, a plurality of times, the coating film forming step and the curing step in the present embodiment will be described.

First, while moving the carriage 50 in the right direction (the direction of the arrow B in FIG. 2), liquid droplets of the radiation curable ink composition for ink jet are ejected onto the recording medium P, where the liquid droplets have one color or a plurality of colors. Then, the coating film is irradiated with the ultraviolet rays by the ultraviolet irradiation apparatus 190A. Next, sub-scanning in which the recording medium P is moved in the sub-scanning direction SS is carried out. It is noted that, in the present specification, one main scanning in which liquid droplets are ejected, while moving the carriage 50 in one direction of the main scanning direction MS, and then the liquid droplets are irradiated with ultraviolet rays, is referred to as one pass.

Thereafter, one main scanning (one pass), in which while moving the carriage 50 in the left direction (the direction of the arrow C in FIG. 2), liquid droplets having one color or a plurality of colors are ejected onto the recording medium P by the method shown in the coating film forming step described above and then the coating film is irradiated with ultraviolet rays by the ultraviolet irradiation apparatus 190B, is further carried out. In this case, the coating film on the recording medium is irradiated with ultraviolet rays by the ultraviolet irradiation apparatus 190A and the ultraviolet irradiation apparatus 190B. Next, sub-scanning in which the recording medium P is moved in the sub-scanning direction SS is further carried out.

By the operation described above, the coating film formed by the first pass is irradiated with ultraviolet rays by two passes, and a total of three times of irradiation with ultraviolet rays, once in the first pass and twice in the second pass, is carried out. In addition, the coating film formed by the second pass is irradiated with ultraviolet rays by one pass, and thus the irradiation with ultraviolet rays is carried out once.

By further repeating such an operation, an image made of a collection of coating films can be formed in a predetermined region.

In addition, the ink jet recording apparatus 20 that is used in the recording method according to the present embodiment may further include a separate ultraviolet irradiation unit (not illustrated in the drawing) downstream in the sub-scanning direction SS, which is the movement direction of the recording medium P. As a result, after all the passes are completed and the formation of the image on the recording medium is completed, the coating film on the recording medium P can sufficiently undergo curing even in the inside thereof.

For example, in a case where the cumulative irradiation energy subjected to irradiation by the ultraviolet irradiation apparatus 190A or 190B is insufficient, and the liquid droplet on the recording medium P does not undergo curing even in the inside thereof, the liquid droplet can reliably undergo curing even in the inside thereof by the ultraviolet irradiation unit in the sub-scanning direction SS.

The ultraviolet irradiation unit in the sub-scanning direction SS may be provided at any position where the liquid droplets on the recording medium P sent in the sub-scanning direction SS can be irradiated with the ultraviolet rays, and it can be installed, for example, on the carriage 50 and downstream (in the sub-scanning direction SS, which is the movement direction of the recording medium P) of the recording head 52. In addition, as the ultraviolet irradiation unit in the sub-scanning direction SS, the same apparatus as the ultraviolet irradiation apparatus 190A (190B) can be used.

FIG. 4 is a schematic cross-sectional view schematically illustrating the ink jet recording apparatus 20. As illustrated in FIG. 4, the ink jet recording apparatus 20 includes a recording head 52, a heating heater 5, a cooling fan 6, and a platen 40. In the ink jet recording apparatus 20, the operation of the entire ink jet recording apparatus 20 is controlled by a control section (not illustrated in the drawing).

The heating heater 5 is a heater that can heat the cured film adhered to the recording medium P, that is, a heater that can be used in a heating step after the curing step. The heating heater 5 can alleviate the stress in the film by heating the recording medium P on which the cured film is recorded, and the heating heater 5 can improve the adhesiveness between the cured film and the recording medium.

It is noted that the heating heater 5 may be an IR heater or the like, and the cured film may be heated by radiation with infrared rays. In addition, although not illustrated in the drawing, a configuration in which the cured film is heated by blowing warm air onto the recording medium P may be adopted. Further, the heating heater 5 may have an aspect in which the heating heater 5 is a conductive (contact) type.

Further, the ink jet recording apparatus 20 may have a cooling fan 6. In a case where the cured film is heated on the recording medium P, and then the cured film is cooled by the cooling fan 6, it may be possible to form the cured film on the recording medium P with further improved adhesiveness.

It is noted that the lower limit of the surface temperature of the recording medium P heated by the heating heater 5 is 30.0° C. or higher, preferably 40.0° C. or higher, and more preferably 50.0° C. or higher. In addition, the upper limit of the surface temperature of the recording medium reached by the heating in the heating step is 150.0° C. or lower, preferably 120.0° C. or lower, and more preferably 100.0° C. or lower. As a result, the cured film can be heated to a similar temperature.

### 4. Examples and Comparative Examples

Hereinafter, the present disclosure will be specifically described with reference to Examples, and the present disclosure is not limited to these Examples. Hereinafter, “part” and “%” are based on mass unless otherwise specified. Unless otherwise specified, the evaluation is carried out in an environment of a temperature of 25° C. and a relative humidity of 40.0%.

### 4.1. Preparation of Each Composition

For the radiation curable ink composition for ink jet in each example described in Table 1 to Table 4, a part of the coloring material, the dispersing agent, and each monomer was weighed and put into a pigment dispersion tank, and a ceramic bead mill having a diameter of 1 mm is put into the tank and stirred to obtain a pigment dispersion liquid in which the coloring material is dispersed in the polymerizable compound. Next, the remaining monomer, the polymerization initiator, and the other components described above are put into a tank for a mixture, which is a stainless container, so that the compositions described in Table 1 to Table 4 are obtained, and they are completely dissolved by mixing and stirring. Then, the pigment dispersion liquid is put thereinto, mixing and stirring are further carried out at normal temperature for 1 hour, and filtering is further carried out with a 5 μm membrane filter to obtain the radiation curable ink composition for ink jet in Table 1 to Table 4. It is noted that the numerical values of the respective components in the table are indicated in terms of % by mass.

Table 1 to Table 4 describe the glass transition temperature (Tg) of each polymerizable compound and the molecular weight of each component. In addition, Table 1 to Table 4 describes, for the composition in each example, the proportion of the monofunctional monomer with respect to the entire composition (% by mass), the proportion of the monofunctional monomer with respect to the total amount of the polymerizable compound contained in the composition (% by mass), the proportion of the polyfunctional monomer with respect to the total amount of the polymerizable compound contained in the composition (% by mass), and the weighted average value of the glass transition temperature of the polymerizable compound contained in the composition (° C.).

The components used in each of the tables are as follows.
CN991: Product name, manufactured by Sartomer Company Inc., urethane diacrylate oligomer
CN9893: Product name, manufactured by Sartomer Company Inc., urethane diacrylate oligomer
MEHQ: Hydroquinone monomethyl ether
LA-7RD: Product name “ADEKA STAB LA-7RD” (2,2,6,6-tetramethyl-4-hydroxypiperidin-1-oxyl), manufactured by ADEKA Corporation Omnirad 819: Product name, manufactured by IGM RESINS, acyl phosphine-based photoinitiator, phenylbis(2,4,6-trimethylbenzoyl)phosphine oxide
TPO-L: Product name “Omnirad TPO-L”, manufactured by IGM RESINS, acyl phosphine-based photoinitiator, ethyl phenyl(2,4,6-trimethylbenzoyl)phosphinate
Speedcure 7010: Product name, manufactured by Sartomer Company Inc., polymeric thioxanthone polymerization initiator (thioxanthone polymer type)
Omnipol TX: Product name, manufactured by IGM RESINS, polymeric thioxanthone polymerization initiator (thioxanthone polymer type)
Speedcure DETX: Product name, manufactured by IGM RESINS, Thioxanthone polymerization initiator having low molecular weight (thioxanthone type), 2,4-diethylthioxanthone
BYK UV3500: Manufactured by BYK Additives & Instruments (surfactant, slip agent)
Solsperse 36000: Product name, manufactured by Lubrizol Corporation (polymer dispersing agent)
Carbon black: C.I. Pigment Black 7

### 4.2. Evaluation Method

### 4.2.1. Curability

The radiation curable ink composition in each example is applied onto a PET film with a bar coater so that the film thickness is 5 μm (in terms of the thickness of the cured film). Irradiation is carried out with a UV-LED (peak wavelength: 395 nm, irradiation intensity: 1,000 mW/cm²), and the irradiation energy subjected to irradiation until a tack free state is reached is determined. The irradiation energy [mJ/cm²] is obtained by measuring the irradiation intensity [mW/cm²] on an irradiation target surface to be irradiated from the light source and determining the irradiation energy from the product of the measured irradiation intensity and the duration time of irradiation [sec].

The measurement of the irradiation intensity is carried out using an ultraviolet intensity meter UM-10 and a light receiving section UM-400 (both of which are manufactured by KONICA MINOLTA SENSING, INC.). In addition, the state of being tack free is determined according to the following conditions. That is, a determination is made depending on whether or not the ink adheres to a cotton swab or whether or not the cured product of the ink on the recording medium has a rubbing scratch. In such a case, the cotton swab used was a Johnson cotton swab manufactured by Johnson & Johnson. The number of times of rubbing is set to 10 times in terms of reciprocation, and the rubbing strength is set to a load of 100 g.

The curability is evaluated according to the following evaluation standards based on the irradiation energy in a case where the tack free state is reached, and the results are shown in Table 5. It is noted that a level of “B” or higher is set as a good level.

### Evaluation Standards

AA: Tack free energy is less than 150 mJ/cm²
A: Tack free energy is 150 mJ/cm² or more and less than 250 mJ/cm².
B: Tack free energy is 250 mJ/cm² or more and less than 350 mJ/cm².
C: Tack free energy is 350 mJ/cm² or more.

### 4.2.2. Blocking

Using an ink jet printer “PX-G5000” (product name, manufactured by Seiko Epson Corporation), printing of a solid pattern image, that is, printing at a dot generation amount of 100% is carried out on a PET film “BONSET” (product name, manufactured by C.I. TAKIRON Corporation), which is a recording medium, at normal temperature and under normal pressure, under conditions of a recording resolution of 600 dpi×600 dpi and a liquid droplet weight of 10 ng, thereby obtaining a printing sample having a film thickness of 5 μm.

It is noted that the solid pattern image is an image in which dots are recorded for all pixels that each indicate a minimum recording unit region defined by the recording resolution. The above printing is carried out, and ultraviolet rays are emitted from the UV-LED in the ultraviolet irradiation apparatus mounted on the side of the carriage to obtain a recorded matter in which a cured film of the ink composition having a film thickness of 5 μm is formed on the recording medium.

The recorded matter obtained as described above is rounded so that the cured film is on the inside, and then the recorded matter is processed into a cylindrical shape. The recorded matter is disposed around a container (glass bottle) which is a packaged body preheated in a constant temperature bath, and the recorded matter is allowed to stand for 10 seconds in the constant temperature bath at 90° C. to cause the recorded matter to shrink and adhere to the container.

In the packaging of the packaged body described above, the presence or absence of adhesion is evaluated by visually observing whether or not the trace left by the cured film adhered to the container is transferred on the recorded matter that is shrunken and brought into close contact with the packaged body, and the blocking resistance is evaluated according to the following evaluation standards, and the results are shown in Table 5. A level of “B” or higher is set as a good level.

### Evaluation Standards

A: The adhesion of the cured film to the container does not occur.
B: The adhesion of the cured film to the container occurs slightly.
C: The adhesion of the cured film to the container occurs (peeling occurs).

### 4.2.3. Odor of Recorded Matter

The recorded matter obtained in the same manner as in the recording of “4.2.1. Curability” described above was smelled and evaluated according to the following standards, and the results are shown in Table 5. A level of “A” or higher is set as a good level.
A: There is no odor or there is a slight odor.
B: There is an odor.
C: There is a strong odor.

### 4.2.4. Adhesiveness

The adhesiveness of the recorded matter obtained in the same manner as the recording of “4.2.1. Curability” described above is evaluated by a cross-cut test in accordance with JIS K5600-5-6. That is, a cut is made in the obtained cured coating film, a transparent adhesive tape is adhered to the cut portion, and the tape is sufficiently rubbed with a finger so that the cured coating film can be seen through the tape. Next, within 5 minutes after the tape is adhered, the tape is peeled off from the cured coating film at an angle close to 60° for 0.5 to 1.0 seconds. Based on the presence or absence of the peeling-off of the cured coating film from the film in this case, the adhesiveness was evaluated according to the following evaluation standards, and the results are shown in Table 5.

### Evaluation Standards

A: The peeling-off of the cured film is observed in less than 20% of the lattice.
B: The peeling-off of the cured film is observed in 10% or more and less than 30% of the lattice.
C: The peeling-off of the cured film is observed in 30% or more of the lattice.

### 4.2.5. Shrinkage Characteristics

In the packaging of the packaged body prepared in the evaluation of the blocking resistance in “4.2.2. Blocking” described above, the situation of occurrence of wrinkling after shrinkage was visually observed, the shrinkage characteristics were evaluated according to the following evaluation standards, and the results are shown in Table 5.

### Evaluation Standards

A: No wrinkles are present in the cured film.
B: Wrinkles are present in the cured film

### 4.3. Evaluation Results

As can be seen from each table, the results are such that the curability, the blocking resistance, and the odor of the recorded matter are favorable in all the radiation curable ink compositions for ink jet in each example, which contain a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C). On the other hand, the results are such that one or more of the curability, the blocking resistance, and the odor of the recorded matter are insufficient in all of the compositions of comparative examples, which do not contain any of a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C).

The present disclosure includes a configuration substantially the same as the configuration described in the embodiment, for example, a configuration having the same function, method, and result, or a configuration having the same purpose and effect. In addition, the present disclosure includes configurations in which non-essential portions of the configuration described in the embodiments are replaced. In addition, the present disclosure includes configurations that exhibit the same action and effect or configurations that can achieve the same object as those of the configurations described in the embodiment. In addition, the present disclosure includes configurations in which a publicly known technology is added to the configurations described in the embodiments.

The following contents are derived from the above-described embodiments and modification examples.

A radiation curable ink composition for ink jet contains a hydroxyl group-containing polymerizable compound (A); a monofunctional polymerizable compound (B) other than the hydroxyl group-containing polymerizable compound (A), the monofunctional polymerizable compound (B) having a glass transition temperature of 10° C. or higher and 90° C. or lower; and a polymeric thioxanthone polymerization initiator (C).

According to the radiation curable ink composition for ink jet, the hydroxyl group-containing polymerizable compound (A) and the polymeric thioxanthone polymerization initiator (C) as a polymerization initiator are contained, and thus the odor of the composition can be reduced, and the curability is also improved. In addition, according to the radiation curable ink composition for ink jet, the monofunctional polymerizable compound (B) having a glass transition temperature of 10° C. or higher and 90° C. or lower are contained, and thus it is possible to suppress the decrease in the blocking properties (and/or adhesiveness to the recording medium) of the coating film, which occurs since the radiation curable ink composition for ink jet contains the hydroxyl group-containing polymerizable compound (A) having a relatively low glass transition temperature.

In the radiation curable ink composition for ink jet, the monofunctional polymerizable compound (B) may include one or more compounds selected from a cyclic ether polymerizable compound and a hydrocarbon ring polymerizable compound.

According to the radiation curable ink composition for ink jet, the curability can be further improved.

In the radiation curable ink composition for ink jet, the cyclic ether polymerizable compound of the monofunctional polymerizable compound (B) may include a cyclic trimethylolpropane formal acrylate. Alternatively, the hydrocarbon ring polymerizable compound of the monofunctional polymerizable compound (B) may include 4-tert-butylcyclohexyl acrylate or 3,3,5-trimethylcyclohexyl acrylate.

According to the radiation curable ink composition for ink jet, the curability of the composition and the anti-blocking properties of the coating film can be further improved.

In the radiation curable ink composition for ink jet, a content of the monofunctional polymerizable compound (B) may be 10% by mass or more and 50% by mass or less with respect to a total amount of the composition.

According to the radiation curable ink composition for ink jet, the curability of the composition and the anti-blocking properties of the coating film can be further improved.

In the radiation curable ink composition for ink jet, the hydroxyl group-containing polymerizable compound (A) may include one or more compounds selected from 4-hydroxybutyl acrylate, hydroxypropyl acrylate, hydroxyethyl acrylate, and acrylic acid 2-hydroxy-3-phenoxypropyl ester.

According to the radiation curable ink composition for ink jet, a more appropriate viscosity is exhibited as a composition for ink jet, and the cured product of the coating film of the composition can have higher adhesiveness to the recording medium.

In the radiation curable ink composition for ink jet, a content of the hydroxyl group-containing polymerizable compound (A) may be 5% by mass or more and 40% by mass or less with respect to a total amount of the composition.

According to the radiation curable ink composition for ink jet, it is possible to further improve the anti-blocking properties of the coating film.

In the radiation curable ink composition for ink jet, the polymeric thioxanthone polymerization initiator (C) may include one or more compounds selected from 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane and a-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl).

According to the radiation curable ink composition for ink jet, the volatilization of the unreacted polymerizable compound and the decomposition product of the polymerization initiator is suppressed, which makes it possible to further reduce the odor.

In the radiation curable ink composition for ink jet, the radiation curable ink composition for ink jet may contain a polymerizable compound having a glass transition temperature of higher than 90° C. such that a content of the polymerizable compound is 10% by mass or more and 50% by mass or less with respect to a total amount of the composition.

According to the radiation curable ink composition for ink jet, it is possible to further improve the anti-blocking properties of the coating film.

In the radiation curable ink composition for ink jet, the polymerizable compound having a glass transition temperature of higher than 90° C. may include a compound having a nitrogen-containing heterocyclic structure.

According to the radiation curable ink composition for ink jet, it is possible to further improve the anti-blocking properties of the coating film.

In the radiation curable ink composition for ink jet, a glass transition temperature of a polymerizable compound to be contained may be 30° C. or higher and 70° C. or lower in terms of a weighted average.

According to the radiation curable ink composition for ink jet, a recorded matter having further excellent blocking properties and shrinkage characteristics is obtained.

In the radiation curable ink composition for ink jet, a monofunctional polymerizable compound may be contained such that a content of the monofunctional polymerizable compound is 50% by mass or more with respect to a total mass of a polymerizable compound to be contained.

According to the radiation curable ink composition for ink jet, the curability of the composition and the anti-blocking properties of the coating film can be further improved.

In the radiation curable ink composition for ink jet, an oligomer may be contained such that a content of the oligomer does not exceed 5% by mass with respect to a total amount of the composition.

According to the radiation curable ink composition for ink jet, it is possible to suppress an increase in the viscosity of the ink composition due to the oligomer and to make the viscosity more appropriate as a composition for ink jet.

The recording apparatus includes the above-described radiation curable ink composition for ink jet, and a head that ejects the radiation curable ink composition for ink jet.

According to the recording apparatus, the above-described radiation curable ink composition for ink jet contains the hydroxyl group-containing polymerizable compound (A) and the polymeric thioxanthone polymerization initiator (C) as a polymerization initiator, and thus it is possible to carry out recording with little odor of the composition, and it is also possible to form an image having good curability. In addition, according to the recording apparatus, the above-described radiation curable ink composition for ink jet according to the present embodiment contains the monofunctional polymerizable compound (B) having a glass transition temperature of 10° C. or higher and 90° C. or lower, and thus it is possible to form an image having good blocking properties (and/or adhesiveness to the recording medium) of the coating film that forms an image that is to be obtained.

What is claimed is:

1. A radiation curable ink composition for ink jet, comprising:
a hydroxyl group-containing polymerizable compound (A);
a monofunctional polymerizable compound (B) other than the hydroxyl group-containing polymerizable compound (A), the monofunctional polymerizable compound (B) having a glass transition temperature of 10° C. or higher and 90° C. or lower; and
a polymeric thioxanthone polymerization initiator (C).

2. The radiation curable ink composition for ink jet according to claim 1, wherein
the monofunctional polymerizable compound (B) includes one or more compounds selected from a cyclic ether polymerizable compound and a hydrocarbon ring polymerizable compound.

3. The radiation curable ink composition for ink jet according to claim 2, wherein
the cyclic ether polymerizable compound of the monofunctional polymerizable compound (B) includes a cyclic trimethylolpropane formal acrylate.

4. The radiation curable ink composition for ink jet according to claim 2, wherein
a hydrocarbon ring polymerizable of the monofunctional polymerizable compound (B) includes one or more compound selected from 4-tert-butylcyclohexyl acrylate and 3,3,5-trimethylcyclohexyl acrylate.

5. The radiation curable ink composition for ink jet according to claim 1, wherein
a content of the monofunctional polymerizable compound (B) is 10% by mass or more and 50% by mass or less with respect to a total amount of the composition.

6. The radiation curable ink composition for ink jet according to claim 1, wherein
the hydroxyl group-containing polymerizable compound (A) includes one or more compounds selected from 4-hydroxybutyl acrylate, hydroxypropyl acrylate, hydroxyethyl acrylate, and acrylic acid 2-hydroxy-3-phenoxypropyl ester.

7. The radiation curable ink composition for ink jet according to claim 1, wherein
a content of the hydroxyl group-containing polymerizable compound (A) is 5% by mass or more and 40% by mass or less with respect to a total amount of the composition.

8. The radiation curable ink composition for ink jet according to claim 1, wherein
the polymeric thioxanthone polymerization initiator (C) includes one or more compounds selected from 1,3-di({α-[1-chloro-9-oxo-9H-thioxanthen-4-yl)oxy]acetyl poly[oxy(1-methylethylene)]}oxy)-2,2-bis({α-[1-chloro-9-oxo-9H-thioxanthen-4-yl)oxy]acetyl poly[oxy(1-methylethylene)]}oxymethyl)propane and a-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl).

9. The radiation curable ink composition for ink jet according to claim 1, wherein
the radiation curable ink composition for ink jet contains a polymerizable compound having a glass transition temperature of higher than 90° C. such that a content of the polymerizable compound is 10% by mass or more and 50% by mass or less with respect to a total amount of the composition.

10. The radiation curable ink composition for ink jet according to claim 1, wherein
a polymerizable compound having a glass transition temperature of higher than 90° C. includes a compound having a nitrogen-containing heterocyclic structure.

11. The radiation curable ink composition for ink jet according to claim 1, wherein
a glass transition temperature of a polymerizable compound to be contained is 30° C. or higher and 70° C. or lower in terms of a weighted average.

12. The radiation curable ink composition for ink jet according to claim 1, wherein
a monofunctional polymerizable compound is contained such that a content of the monofunctional polymerizable compound is 50% by mass or more with respect to a total mass of a polymerizable compound to be contained.

13. The radiation curable ink composition for ink jet according to claim 1, wherein
an oligomer is contained such that a content of the oligomer does not exceed 5% by mass with respect to a total amount of the composition.

14. A recording apparatus comprising:
the radiation curable ink composition for ink jet according to claim 1; and
a head that ejects the radiation curable ink composition for ink jet.
